(19) United States
(12) Patent Application Publication
(10) Pub. No.: US 2007/0175117 A1
(43) Pub. Date: Aug. 2, 2007

(54) Storm shutter look out

(76) Inventor: Amos Deloy Brown, North Miami, FL (US)

Correspondence Address: CHRISTOPHER D. HARRINGTON, 5300 CORPORATE GROVE DR SE, SUITE 350, GRAND RAPIDS, MI, 49512, US

(21) Appl. No.: 11/322,785

(22) Filed: Jan. 3, 2006

(51) Int. Cl. E06B 1/04

(52) U.S. Cl. 52/204.1

(57) ABSTRACT

A novel look out portal for storm shutters and the like used to protect buildings is disclosed and comprises an assembly with an interior frame and an exterior frame enclosing at least one transparent panel in between, and also including a cover associated with the interior frame that is moveable from a closed position to an open position where the cover, the interior frame and the exterior frame, are all fabricated from materials that are resistant to the impacts anticipated during a hurricane or tropical storm. In the alternate, the look out portal of the present invention may also be installed onto a wood panel covering a window or doorway.

### RELATED APPLICATIONS

Not applicable.

### STATEMENT REGARDING GOVERNMENTALLY FUNDED WORK

Not applicable.

### BACKGROUND OF THE INVENTION

The present invention relates to a look out portal for storm shutters. More particularly, the present invention relates to a look out portal that is integrated into a storm shutter system of the type used for protection from tropical storms, hurricanes, and other forms of severe weather.

Prior art devices for use as storm shutters or for enhancing storm shutter utility are known and include U.S. Pat. No. 5,787,642 (Coyle, et al) which discloses a design for a storm shutter that incorporates a transparent or translucent polycarbonate sheet into the shutter so as to provide some light transmission and some visibility. This is a complete storm shutter in this instance and is mounted directly over glass doors or windows to provide protection. The installation is intended to be permanent and continuous.

In U.S. Pat. No. 6,079,168 (Shaver) translucent and/or transparent polycarbonate panels are interspersed within a corrugated storm shutter system. This design does have the advantage of providing light and some visual transparency however it requires a special approach to fabrication and assembly. Similarly, in U.S. Pat. No. 5,228,238 (Fenkell) a special storm shutter design is disclosed employing at least two panels of polycarbonate sheet for protection and with special fabrication and assembly considerations. Both of these concepts result in a final product that leaves polycarbonate panel exposed to the storm conditions which is typically considered to be less than desired when trying to maximize protection from the impacts of debris and weather.

In U.S. Pat. No. 6,615,555 B2 (Madden) there is shown another system that uses alternating panels of corrugated steel and polycarbonate panels. In U.S. Pat. No. 4,685,261 (Seaquist) a storm shutter construction is shown where polycarbonate (or similar) panels are mountable in a frame that is placed in front of a regular glass window. Storm shutters are shown in both U.S. Design Pat. No. D361,843 (Pangborn) and U.S. Pat. No. 5,957,186 (Boswell) that are based on steel constructions. The latter invention does provide slots in their steel planks for ventilation and light transmission, but the concepts do not contemplate a specific system for allowing a look out portal for a person to use for visual inspection of exterior conditions.

The prior art devices have not solved certain problems that have been observed with storm shutters. In particular, the use of a polycarbonate panel remains suspect as a weaker element than steel or aluminum panels under storm conditions. During hurricanes of higher category intensities, the potential for wind driven impacts is well known and a major cause of damage to property and for injury to people. Therefore, use of a polycarbonate panel, whether by itself or as a component in a steel-polycarbonate system, is less then the maximal protection level that would be accorded a system that is completed protected by a steel or aluminum shield. In addition, the use of ever-thicker polycarbonate panels to provide a more robust shield reduces transparency and typically nullifies the use of the system for “look out” purposes.

The problems in providing a look out portal in traditional storm shutter systems while maintaining the maximal protection have been solved in the present invention. The distinctions noted above, as well as the benefits and enhancements of the present invention will become more apparent in the discussion below.

### SUMMARY OF THE INVENTION

A novel improvement in storm shutters is provided by the present invention is comprised of a look out portal for installation in a conventional storm shutter system, the look out portal including an interior frame and an exterior frame which together enclose a transparent panel (Plexiglass or polycarbonate) and where the interior frame also includes a cover that is slideable between a closed position and an open position, and where the cover is secured within the enclosure formed by the interior frame and the exterior frame.

More specifically, the present invention comprises a look out portal that is compatible with installation in a storm shutter, in a vertical or horizontal orientation, and integrally within the storm shutter panels.

### BRIEF DESCRIPTION OF THE DRAWINGS

FIG. 1 is a front elevational view of the storm shutter look out portal of the present invention as installed in a storm shutter system with horizontal panels and as viewed from the interior side of the installation.

FIG. 2 is a left side isometric view of the storm shutter look out portal of the present invention shown in isolation and with the cover in the partially opened position.

FIG. 3 is a side cross sectional view storm shutter look out portal of the present invention taken along Section 3-3.

FIG. 4 is a rear elevational view of the storm shutter look out of the present invention as viewed from the exterior side of the look out portal.

### DETAILED DESCRIPTION OF THE PREFERRED EMBODIMENTS

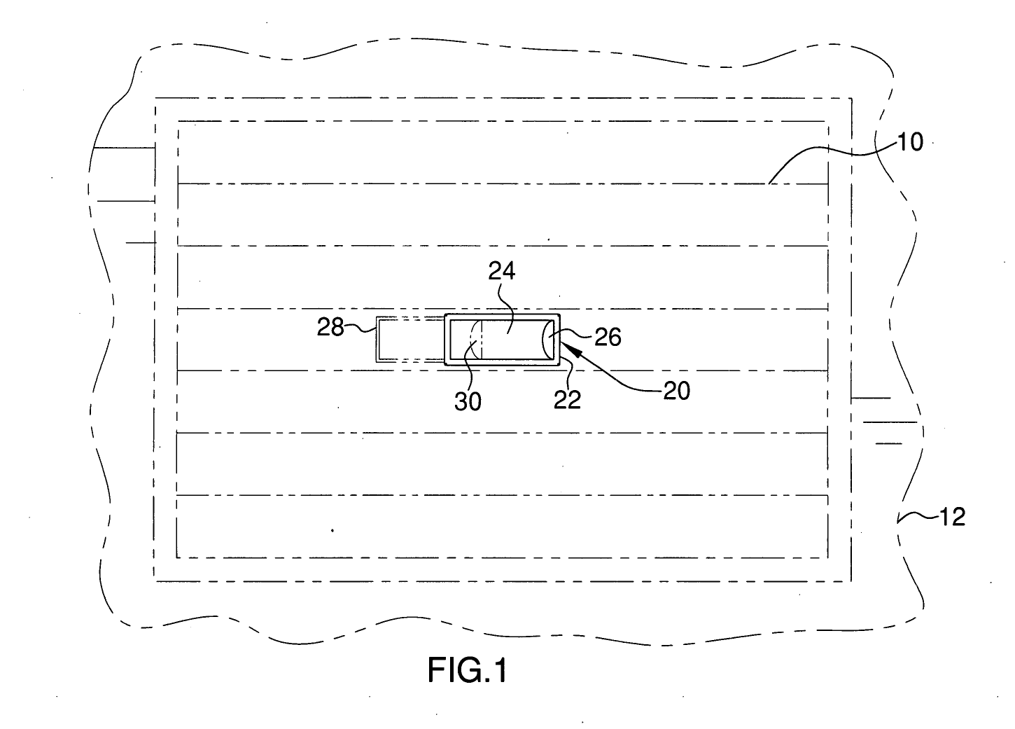

A novel storm shutter look out portal in accordance with the present invention is disclosed in the drawings. In particular, FIG. 1 shows typical storm shutters 10 as installed over a doorway and with adjacent wall 12. The look out portal 20, in FIG. 1, is shown as viewed from the interior and includes the frame 22, the cover 24, the cover handle 26. The solid line representation of the cover 24 shows it in the closed position and the phantom line representation of the cover 28 shows it in the open position.

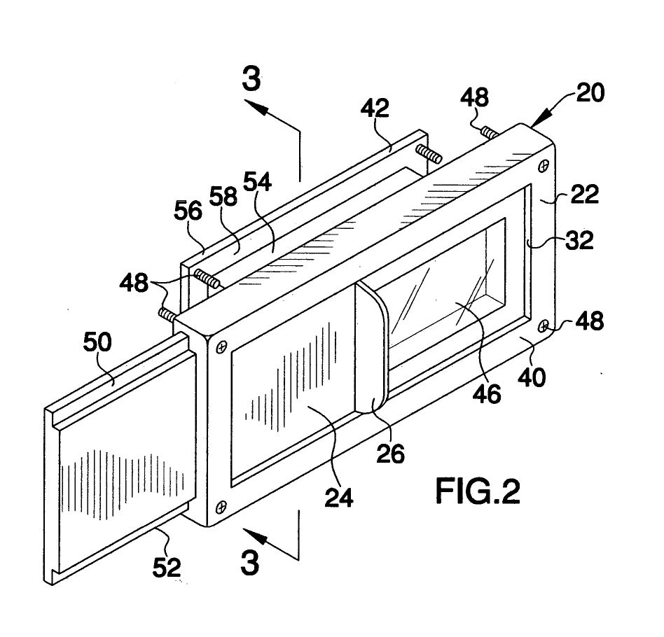

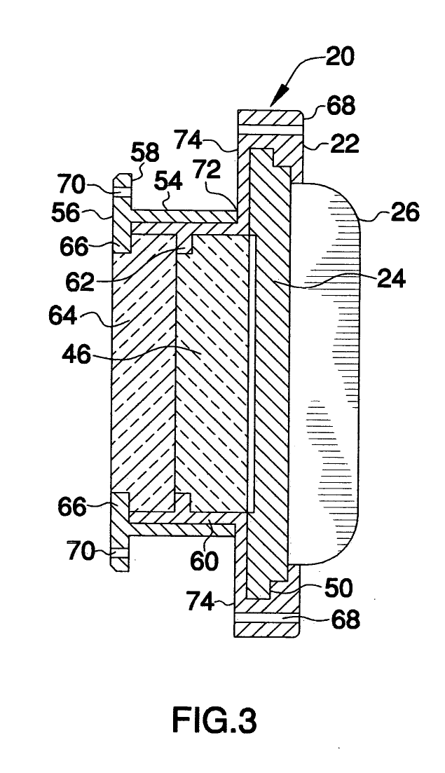

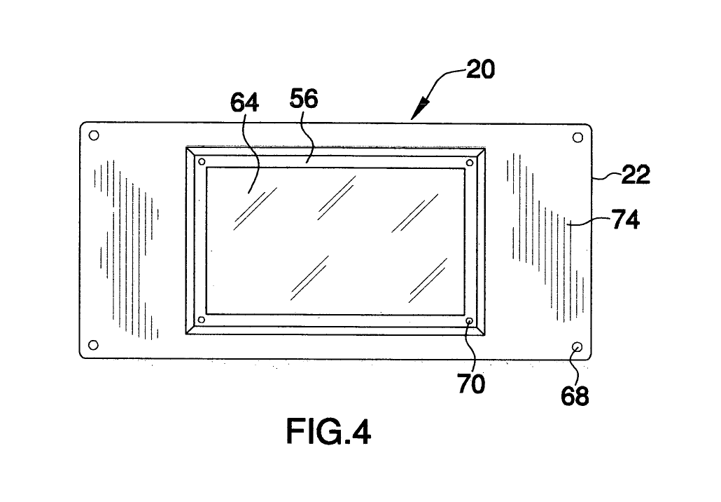

Turning now to FIG. 2, the look out portal 20 is shown in more detail with the look out portal interior side 40 and the look out portal exterior side 42, including the cover stop 32, the Plexiglas 46, the fasteners 48, the cover flange 50, the frame entrance 52, the portal 54, the exterior frame 56, and the exterior frame face 58. FIGS. 3 and 4 reveal the frame body 60, the frame body flange 62, the exterior Plexiglas 64, the exterior Plexiglas flange 66, the frame through holes 68 and the exterior frame through holes 70, the exterior frame cowling 72 and the frame face 74.

Before illustrating the application of the present invention to storm shutters, background information on storm shutter systems is necessary. The present invention is preferably applied to rolling shutters or accordion type shutters that are designed for storm conditions. In the United States, the Gulf, the South East, and the East Coast regions are notorious for receiving tropical storms and hurricanes. In fact, the recent disaster associated with hurricane Katrina serves to underscore this situation and the intensity with which these storms can affect a region.

Florida has probably incurred the most experience with such weather and it has become very common for commercial and residential property owners in that state to install protective systems on their buildings in order to minimize the impacts from storm related conditions. In particular, there is a great deal of concern related to impacts from debris that can be propelled at great velocity and of such mass as to literally break down conventional doors, windows, and other lightly protected areas on buildings. It is this situation that has spawned a thriving industry that supplies specialized storm shutter systems which come in different forms. The ones of primary interest with respect to the present invention are the rolling shutters and the accordion shutters, although the teachings herein may be applicable to other systems, including solid panel storm shutters.

A typical rolling shutter has a series of “planks” that are hinged to each other at their long sides so they can be rolled and unrolled in a tambour fashion. The planks may be formed as corrugated types (as in U.S. Pat. No. 6,615,555 B2) or they may be boxed (as in U.S. Pat. No. 5,957,186). The planks of the rolling shutter systems can be oriented horizontally so they will roll down from a storage point above the door or window, or they can be oriented vertically and can be rolled to cover a door or window from a stored point along one side of the window frame or door frame. Similarly, the accordion style of shutter system uses planks that may be thinner but which are hinged in accordion fashion. They are typically split so that one set of accordion planks is affixed to one side of a window, for instance, and the other set is affixed to the opposite side of the window and when extended they met approximately in the middle of the window. For the purposes of the present invention, the look out portal may be fitted to any shutter system that employs a planking or surface that will allow it to be installed.

In use, the storm shutter look out portal 20 of the present invention, is affixed to a shutter system 10 by first cutting out a through hole in the shutter system. The through hole needs to be of a size that will allow the portal 54 zone of the look out 20 to extend through thereby bringing together the frame 22 and the exterior frame 56 in engagement as seen in FIG. 3. The engagement occurs where the exterior frame inner edge 72 encloses the frame body 60 in something akin to a telescoping fashion. The space that is left between the exterior frame face 58 and the frame face 74 can be sized to fit the width of a plank in a shutter system, or to roughly approximately the thickness of a wood panel, such that when the frame 22 and the exterior frame 56 are brought together a snug fit can be obtained. This distance will vary with the application and is well within the capability of one skilled in the art to consider. Although it is understood, the exterior frame 56 is installable on the exterior side of a storm shutter (or the like) and the interior frame 22 is installable on the interior side of a storm shutter (or the like).

One advantage of the present invention is the usage of the cover 24 that can be selectively operated to provide a visual check on the exterior conditions. As can be seen in the drawings, the cover 24 is moveable from a closed position to an open position 28 where the user can view through the Plexiglas 46, through the portal 54, to the exterior. During a storm, the user will deploy the storm shutter system of their choice, and with the look out portal installed, it will be possible for the user to periodically move the cover 24 to the open position 28 when desired. The cover 24 is preferentially constructed from a metal, such as a formed steel part, or in the alternative, it may be formed from a robust plastic resin that has been selected to withstand the anticipated impact loading from the storm. The cover 24 provides the additional level of protection, consistent with the level provided by the storm shutter 10 itself. This is important since many of the viewing devices in the prior art rely strictly on the polycarbonate/polycarbonate to withstand the impacts. The present invention provides both safety and a reasonable viewing mode since the Plexiglas 46 and the exterior Plexiglas 64 are of thicknesses that still provide good visual acuity in total in the preferred embodiment, although they can be increased in thickness, if needed, to suit the application. Still, the thickness of the Plexiglas in the preferred embodiment is supported by the structure of the cover 24 when in the closed position. This design, therefore, prevents the look out portal 20 from breaking during an impact unlike the prior art designs that rely solely on a translucent plastic shield.

The present invention can be applied to regular wood panels in addition to usage on storm shutters. Wood panels, typically plywood, are used as storm barriers just as storm shutters may be considered to be storm barriers, except the use of the wood panels is generally considered a temporary measure whereas the storm shutters are typically a permanent fixture. The same benefits would be obtained although the sizing of the look out portal 20 is preferentially optimized to fit the typical storm shutter 10 system. In either case, installation can take place on an aftermarket basis, with the homeowner needing only to cut a hole approximating the outer dimension of the portal 54 in the storm shutter 10. The look out portal 20, in dissembled form, can be installed into the hole cut by bringing together the interior frame 22 and the exterior frame 56 with the components such as the Plexiglas 22 and the exterior Plexiglas 56 installed in between. The assembly is then affixed to the storm shutter 10 by means of fasteners 48 that can comprise sheet metal screws, or bolts, that tie in with the storm shutter, or in the case of on installation on a wood panel, the fasteners 48 may be wood screws.

The present invention could be practiced by eliminating the exterior Plexiglas 56 although it is believed that this would also result in a reduction in safety as well. Other variations can be contemplated in terms of the arrangement of the components or the like, without departing from the spirit and scope of the invention.

I claim:

1. A look out portal for use with a storm shutter for providing a look out during storm conditions, the look out portal comprising:
an interior frame for installation on the interior side of a storm shutter;
an exterior frame for installation on the exterior side of a storm shutter;
at least one transparent panel;
a cover transitionable between a closed position and an open position; and,
when installed, said exterior frame and said interior frame enclose the transparent panel and said cover is slideably associated with the interior frame such that when the cover is transitioned to the open position it is possible for a user to obtain a view through the look out portal and when the cover is transitioned to the closed position the look out portal is capable of resisting storm related impacts.

2. The look out portal of claim 1, where the look out portal includes two transparent panels.

3. The look out portal of claim 1, where the interior frame and the exterior frame compatibly fit onto a plank in a storm shutter system.

4. The look out portal of claim 1, where the interior frame and the exterior frame are fastened to the storm shutter by sheet metal screws.

5. The look out portal of claim 1, where the interior frame and the exterior frame are in telescopic engagement.

6. A look out portal for use with a storm shutter for providing a look out during storm conditions, the look out portal comprising:
an interior frame for installation on the interior side of a storm shutter;
an exterior frame for installation on the exterior side of a storm shutter, and where upon installation, the exterior frame and the interior frame telescopically engage;
at least one transparent panel;
a cover transitionable between a closed position and an open position; and,
when installed, said exterior frame and said interior frame enclose the transparent panel and said cover is slideably associated with the interior frame such that when the cover is transitioned to the open position it is possible for a user to obtain a view through the look out portal and when the cover is transitioned to the closed position the look out portal is capable of resisting storm related impacts.

7. The look out portal of claim 6, where the interior frame and the exterior frame are fastened to the storm shutter by sheet metal screws.

8. The look out portal of claim 6, where the interior frame and the exterior frame compatibly fit onto a plank in a storm shutter system.

9. The look out portal of claim 6, where the look out portal includes two transparent panels.

10. A look out portal for use with storm barriers for providing a look out during storm conditions, the look out portal comprising:
an interior frame for installation on the interior side of a storm barrier;
an exterior frame for installation on the exterior side of a storm barrier, and where upon installation, the exterior frame and the interior frame telescopically engage;
at least one transparent panel;
a cover transitionable between a closed position and an open position; and,
when installed, said exterior frame and said interior frame enclose the transparent panel and said cover is slideably associated with the interior frame such that when the cover is transitioned to the open position it is possible for a user to obtain a view through the look out portal and when the cover is transitioned to the closed position the look out portal is capable of resisting storm related impacts.

11. The look out portal of claim 10, where the storm barrier is a wood panel.

12. The look out portal of claim 10, where the storm barrier is a storm shutter.

13. The look out portal of claim 10, where the look out portal includes two transparent panels.

14. The look out portal of claim 12, where the interior frame and the exterior frame compatibly fit onto a plank in a storm shutter system.
